(19) United States
(12) Patent Application Publication
(10) Pub. No.: US 2025/0248883 A1
(43) Pub. Date: Aug. 7, 2025

(54) MULTI-FUNCTIONAL BOTTLEHEAD FOR THERAPEUTIC APPLICATION

(71) Applicant: SHENZHEN NUON MEDICAL EQUIPMENT CO., LTD., Shenzhen (CN)

(72) Inventors: ALAIN DIJKSTRA, Amstelveen (NL); LI XIANG, Shenzhen (CN); Tu Mingjun, Shenzhen (CN)

(73) Assignee: SHENZHEN NUON MEDICAL EQUIPMENT CO., LTD., Shenzhen (CN)

(21) Appl. No.: 18/788,212

(22) Filed: Jul. 30, 2024

(30) Foreign Application Priority Data
Feb. 4, 2024 (CN) 202420267855X
Feb. 4, 2024 (CN) 2024202679001

(51) Int. Cl. A61H 15/02; A61H 15/00

(52) U.S. Cl. CPC A61H 15/02; A61H 2015/0042; A61H 2201/105; A61H 2205/022

(57) ABSTRACT

Embodiments of the present invention provide a multi-functional bottle head and a bottle body. The multi-functional bottle head comprises: a shell, an input end and an output end arranged relative to the input end. The output end of the housing body is provided with a mounting hole; the massage piece is used for evenly applying the liquid medicine to the skin and massaging the skin, and the massage piece is installed at the output end of the shell; one or more stimulation elements installed in the mounting hole.

### TECHNICAL FIELD

The present invention generally relates to recreational and therapeutic devices and, more particularly, to a multi-functional bottlehead and a bottle body.

### BACKGROUND ART

The existing facial phototherapy beauty device is mainly a phototherapy mask. The phototherapy mask comprises a mask, a power supply connected to the mask, and a controller connected to the power supply. When a user carries out a phototherapy session, the metabolism of the skin gets accelerated, and the skin is prone to water loss. The timely hydration of skin is achieved by applying a cosmetic. This kind of facial phototherapy beauty device has a large size, multiple accessories, which is inconvenient to store and carry. The device has a single function, multiple beauty and skin care steps, and a poor user experience.

The existing bottlehead mechanism is provided with a diversion channel for exporting the liquid medicine and a circuit component for cosmetic treatment. When a user performs skin treatment, the liquid medicine can flow out from the diversion channel so that it is easily applied to the skin, and the circuit assembly can carry out cosmetic massage to the skin. The circuit components and diversion channels inside the bottle head mechanism occupy a huge space that makes the cross-sectional area of the bottle head larger, and the bottlehead collides during use. For example, when carrying out beauty treatment on the side of the nose and other parts, the bottle head mechanism is easily interfered with by the nose block, which affects the user's use experience.

### OBJECTS OF THE INVENTION

Some of the objects of the invention are as follows:

An object of the present invention is to provide a multi-functional bottle head for providing therapy and massage to the skin.

Another object of the present invention is to provide a multi-functional bottlehead that improves the integration of the product by reducing the number of accessories, thereby helping in reducing the volume of the product.

Another object of the present invention is to provide a multi-functional bottle head with a light transmission plate to prevent the internal structure of the shell from being exposed that is conducive for improving the appearance.

Another object of the present invention is to provide a multi-functional bottlehead wherein the processing and assembly of the shell are convenient.

Another object of the present invention is to provide a multi-functional bottlehead that has an inductive device to control and activate the stimulation element.

Another object of the present invention is to provide a multi-functional bottlehead with a large massage area coverage.

Another object of the present invention is to provide a multi-functional bottle head where the size of the bottlehead mechanism close to the skin is less, which helps to reduce the interference with other parts during the application and massage process.

### SUMMARY OF THE INVENTION

According to a first aspect of the present invention, a multi-functional bottlehead is provided. The multi-functional bottlehead comprising: a housing having a first end for connecting to a bottle main body and a second end; a mounting hole on the second end; one or more massage piece installed on the second end of the housing; at least one stimulation element installed in the mounting hole.

In one embodiment of the invention, the second end of the housing is provided with a limiting plate, said limiting plate has a first opening for the one or more massage piece and a second opening for a light transmission plate, the diameter of the first opening is less than the diameter of the massage piece.

In one embodiment of the invention, the limiting plate comprises a positioning frame having an inner cavity for positioning the at least one stimulation element.

In one embodiment of the invention, the bottle head further comprising a first hole section having a first opening and a second opening corresponding to the first opening and the second opening of the limiting plate, the first opening comprises one or more grooves for placing the one or more massage piece.

In one embodiment of the invention, the multi-functional bottle head further comprising a second hole section in the second end of the housing, the second hole section having a first opening and second opening corresponding to the first opening and the second opening of the limiting plate.

In one embodiment of the invention, the the one or more massage piece is a ball.

In one embodiment of the invention, the at least one stimulation element is selected from a group consisting of Light Emitting Diodes (LEDs), lasers, heating elements, cooling elements, vibration elements, electrodes, micro-current element and combinations thereof.

In one embodiment of the invention, the light transmission plate has a butting block to separate two adjacent stimulation elements.

In one embodiment of the invention, the multi-functional bottle head further comprising an inductive switch device for regulating the activation and control of the one or more stimulation elements.

According to a second aspect of the present invention, a multi-functional bottlehead is provided. The multi-functional bottle head comprising: a shell comprising: an assembly segment for connecting with a bottle body, the assembly segment has a first runner hole; a derivation segment having a first end and a second end, the second end is connected with the assembly segment, the derivation segment has a plurality of second runner hole, wherein the outlet end of the first runner hole is connected with the inlet end of each of the plurality of second runner hole; wherein the cross-sectional area of the derivation segment is less than the cross-sectional area of the assembly segment; and one or more coating parts installed at the outlet of the second runner hole, the coating part applies the liquid medicine to the skin of a user.

In one embodiment of the invention, the derivation segment comprises: a connecting segment connected with the assembly segment; a supporting segment connected with the coating part; a gradient segment connects the supporting segment with the connecting segment; wherein the cross-sectional area of the gradient segment decreases moving from the connecting segment to the supporting segment.

In one embodiment of the invention, the thermal regulating element comprises a heating element, a cooling element, a peltier element, or a combination thereof.

In one embodiment of the invention, the gradient segment is bending arc-shaped.

In one embodiment of the invention, the arc of the gradient segment bends at an angle of 20°-85°.

In one embodiment of the invention, the second runner hole is bent in an arc shape.

In one embodiment of the invention, the supporting segment is provided with a plurality of support areas, each of the plurality of support areas corresponds to each of the plurality of second runner holes.

In one embodiment of the invention, the multi-functional bottle head further comprising a manifold pipe, said manifold comprises a main pipe section and a plurality of branch pipe sections diverting from the main pipe section, said main pipe section is connected with the outlet end of the first runner hole, and the outlet end of each of the plurality of branch pipe section is connected with the inlet end of the corresponding second runner hole.

In one embodiment of the invention, the plurality of coating parts are ball-shaped and accommodated in a groove in the supporting segment.

In one embodiment of the invention, the bottom of the groove is provided with a diversion groove connected with the outlet end of each of the plurality of second runner holes.

In one embodiment of the invention, the assembly segment comprises a bracket and a shell sleeved outside a support, the support is connected with the derivation segment.

In one embodiment of the invention, the multi-functional bottle head further comprising a circuit assembly comprises one or more stimulation elements, a circuit board connected to the one or more stimulation elements, a switching device and a power supply.

In one embodiment of the invention, the at least one stimulation element is selected from a group consisting of Light Emitting Diodes (LEDs), lasers, heating elements, cooling elements, vibration elements, electrodes, micro-current element and combinations thereof.

In the context of the specification, the term “processor” refers to one or more of a microprocessor, a microcontroller, a general-purpose processor, a Field Programmable Gate Array (FPGA) or an Application Specific Integrated Circuit (ASIC), and the like.

In the context of the specification, the phrase “memory unit” refers to volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc.

In the context of the specification, the phrase “storage device” refers to a non-volatile storage memory such as EPROM, EEPROM, flash memory, or the like.

In the context of the specification, the phrase “communication interface” refers to a device or a module enabling direct connectivity via wires and connectors such as USB, HDMI, VGA, or wireless connectivity such as Bluetooth or Wi-Fi, or Local Area Network (LAN) or Wide Area Network (WAN) implemented through TCP/IP, IEEE 802.x, GSM, CDMA, LTE, or other equivalent protocols.

In the context of the specification, the phrase “communication network” refers to a group of several connected devices including computing devices (such as desktops, mobile handheld devices, tablet PCs, notebooks, etc.), local and remotely located servers (such as web servers, application servers, database servers, Application Program Interface (API) servers, load balancers, compute nodes, and the like), routers, antennas, modems, multiplexers, demultiplexers, and the like. In that regard, the aforementioned connected devices may be able to exchange data signals through wired and/or wireless means as per several combinations of several different communication protocols such as 802.11 (Wi-Fi), 802.3 (Ethernet), Bluetooth, NFC, ZigBee and 3GPP protocols such as HSPA, HSDPA, LTE, GSM, CDMA, WLL and the like.

In the context of this specification, terms like “light”, “radiation”, “irradiation”, “emission” and “illumination”, etc. refer to electromagnetic radiation in frequency ranges varying from the Ultraviolet (UV) frequencies to Infrared (IR) frequencies and wavelengths, wherein the range is inclusive of visible light, UV and IR frequencies and wavelengths. It is to be noted here that UV radiation can be categorized in several manners depending on respective wavelength ranges, all of which are envisaged to be under the scope of this invention. For example, UV radiation can be categorized as, Hydrogen Lyman-a (122-121 nm), Far UV (200-122 nm), Middle UV (300-200 nm), and Near UV (400-300 nm). The UV radiation may also be categorized as UVA (400-315 nm), UVB (315-280 nm), and UVC (280-100 nm) Similarly, IR radiation may also be categorized into several categories according to respective wavelength ranges which are again envisaged to be within the scope of this invention. A commonly used subdivision scheme for IR radiation includes Near IR (0.75-1.4 μm), Short-Wavelength IR (1.4-3 μm), Mid-Wavelength IR (3-8 μm), Long-Wavelength IR (8-15 μm) and Far IR (15-1000 μm).

In the context of the specification, when an element is referred to as being “fixed to” or “disposed to” another element, it may either directly on another element or indirectly on that other element. When a component is said to be “connected” or “connected to” another component, it may be directly connected to another component or indirectly connected to other component on the piece.

In the context of the specification, the terms “first’, “second” and “third” are only used for descriptive purpose and does not implicate the relative importance or to implicitly indicate the quantity of technical features indicated.

In the context of the specification, the term “plurality” means two or more than two, unless otherwise indicated.

In the context of the specification, the term “several” means more than one, unless otherwise specified.

In the context of the specification, “Light Emitting Diodes (LEDs)” refer to semiconductor diodes capable of emitting electromagnetic radiation when supplied with an electric current. The LEDs are characterized by their superior power efficiencies, smaller sizes, rapidity in switching, physical robustness, and longevity when compared with incandescent or fluorescent lamps. In that regard, the one or more LEDs may be through-hole type LEDs (generally used to produce electromagnetic radiations of red, green, yellow, blue and white colors), Surface Mount Technology (SMT) LEDs, Bi-color LEDs, Pulse Width Modulated RGB (Red-Green-Blue) LEDs, and high-power LEDs, etc.

Materials used in the one or more LEDs may vary from one embodiment to another depending upon the frequency of radiation required. Different frequencies can be obtained from LEDs made from pure or doped semiconductor materials. Commonly used semiconductor materials include nitrides of Silicon, Gallium, Aluminum, and Boron, and Zinc Selenide, etc. in pure form or doped with elements such as Aluminum and Indium, etc. For example, red and amber colors are produced from Aluminum Indium Gallium Phosphide (AlGalInP) based compositions, while blue, green, and cyan use Indium Gallium Nitride based compositions. White light may be produced by mixing red, green, and blue lights in equal proportions, while varying proportions may be used for generating a wider color gamut. White and other colored lightings may also be produced using phosphor coatings such as Yttrium Aluminum Garnet (YAG) in combination with a blue LED to generate white light and Magnesium doped potassium fluorosilicate in combination with blue LED to generate red light. Additionally, near Ultraviolet (UV) LEDs may be combined with europium-based phosphors to generate red and blue lights and copper and zinc doped zinc sulfide-based phosphor to generate green light.

In addition to conventional mineral-based LEDs, one or more LEDs may also be provided on an Organic LED (OLED) based flexible panel or an inorganic LED-based flexible panel. Such OLED panels may be generated by depositing organic semiconducting materials over Thin Film Transistor (TFT) based substrates. Further, discussion on generation of OLED panels can be found in Bardsley, J. N (2004), “International OLED Technology Roadmap”, IEEE Journal of Selected Topics in Quantum Electronics, Vol. 10, No. 1, that is included herein in its entirety, by reference. An exemplary description of flexible inorganic light-emitting diode strips can be found in granted U.S. Pat. No. 7,476,557 B2, titled “Roll-to-roll fabricated light sheet and encapsulated semiconductor circuit devices”, which is included herein in its entirety, by reference.

In several embodiments, the one or more LEDs may also be micro-LEDs described through U.S. Pat. Nos. 8,809,126 B2, 8,846,457 B2, 8,852,467 B2, 8,415,879 B2, 8,877,101 B2, 9,018,833 B2 and their respective family members, assigned to NthDegree Technologies Worldwide Inc., which are included herein by reference, in their entirety. The one or more LEDs, in that regard, may be provided as a printable composition of the micro-LEDs, printed on a substrate.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 is the front view of a multi-functional bottle head installed on a bottle in accordance with an embodiment of the present invention.

FIG. 2 is a three-dimensional structure of the multi-functional bottlehead in accordance with an embodiment of the present invention.

FIG. 3 is an exploded view of a first shell and a mounting seat of FIG. 2 in accordance with an embodiment of the present invention.

FIG. 4 is an exploded view of a translucent plate and one or more stimulation elements in accordance with an embodiment of the present invention.

FIG. 5 shows a cross-sectional structure of the multi-functional bottle head in accordance with an embodiment of the present invention.

FIG. 6 illustrates a zoomed view of component A of FIG. 5 in accordance with an embodiment of the present invention.

FIG. 7 is a schematic diagram of the three-dimensional structure of a multi-functional bottlehead with a flow mechanism provided in the embodiment of the present application;

FIG. 8 is the exploded view of the multi-functional bottlehead of FIG. 7 in accordance with an embodiment of the present invention.

FIG. 9 is a magnified view of a shell depicted as A in FIG. 8 in accordance with an embodiment of the present invention.

FIG. 10 shows a cross-sectional side view of the multi-functional bottle head with the flow mechanism in accordance with an embodiment of the present invention.

FIG. 11 shows a cross-sectional back view of the multi-functional bottle head with the flow mechanism in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

The terms “a” and “an” herein do not denote a limitation of quantity, but rather denote the presence of at least one of the referenced items. The terms “having”, “comprising”, “including”, and variations thereof signify the presence of a component.

Embodiments of the present invention disclose a “multi-functional bottle head” and a bottle body. The multi-functional bottle head comprising: a housing having an input end for connecting to a bottle main body and an output end that is arranged relative to the input end, and the output end of the housing is provided with a mounting hole; one or more massage piece for evenly applying a liquid medicine to skin of a user and massaging the skin, said one or more massage piece are installed at the output end of the housing; at least one stimulation element installed in the mounting hole; a light transmission plate installed in the mounting hole; a Printed circuit board (PCB) installed in the housing, said PCB is electrically connected to the at least one stimulation element and used for driving the at least one stimulation element.

Several additional functionalities may also be added to the therapeutic device. For example, the output end of the housing is provided with a limiting plate for limiting the massage piece to the output end. In coordination, the limiting plate has a positioning frame inserted into the mounting hole, and the stimulation element is placed in the positioning frame. The mounting hole has a supporting frame inserted into the positioning frame to stop positioning the stimulation elements. At one of the end of the light transmission plate close to the stimulation element, a first flange is provided. At one end of the second opening away from the input end, a second flange is provided, the second flange cooperate with the stop to locate the first flange. Alternatively, the mounting hole comprises a first hole section and a second hole section for the line to pass through, the second hole section is connected with one end of the first hole section close to the input end, and the light transmission plate and the stimulation element are located in the first hole section. The one or more massage piece is a ball, and the output end is provided with a groove for positioning the ball. The bottom of the groove has a liquid outlet hole. The diameter of the first opening is smaller than the diameter of the ball.

The at least one stimulation element is selected from a group consisting of Light Emitting Diodes (LEDs), lasers, heating elements, cooling elements, vibration elements, electrodes, and combinations thereof. This enables the multi-functional bottle to provide a wide range of alternate therapies.

In some embodiment, a butting block is arranged between the adjacent two stimulation elements, the butting block is arranged on one side of the light transmission plate close to the lamp board, and the butting block is supported on a board.

In some embodiment, the board is provided with a positioning hole, and the light transmission plate is provided with a positioning post that is inserted into the positioning hole in a match. There are two positioning holes arranged along the length direction of the board. The number of the positioning posts is two, and the two positioning columns correspond to two positioning holes respectively.

In an embodiment, the multi-functional bottle head further comprises an inductive device and/or a switch device for controlling the start and stop of the one or more stimulation elements.

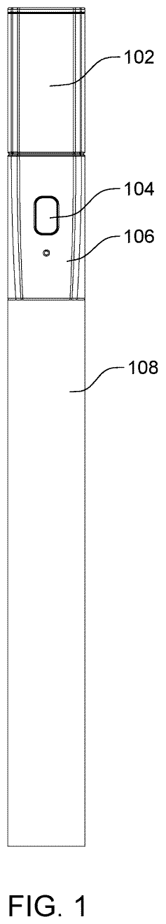

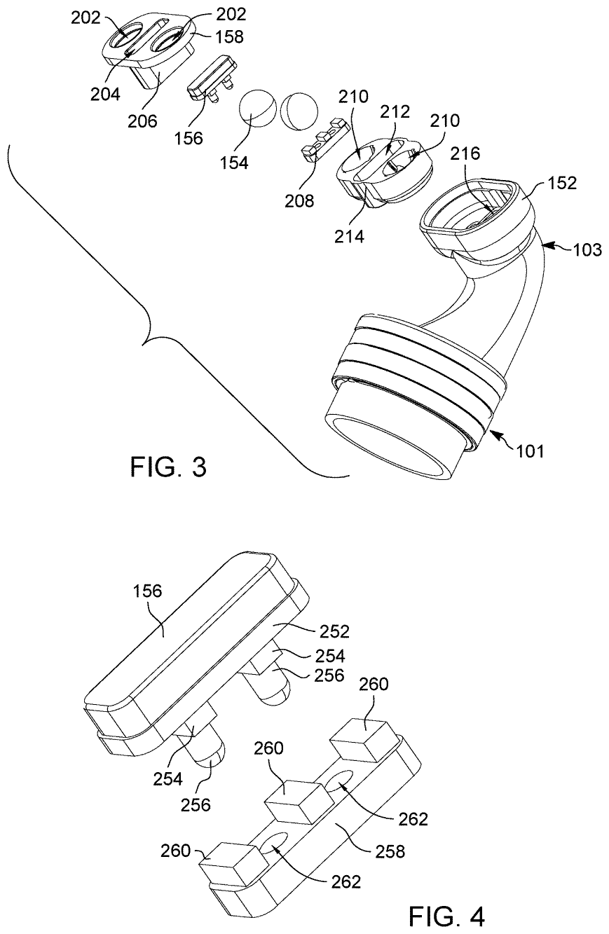

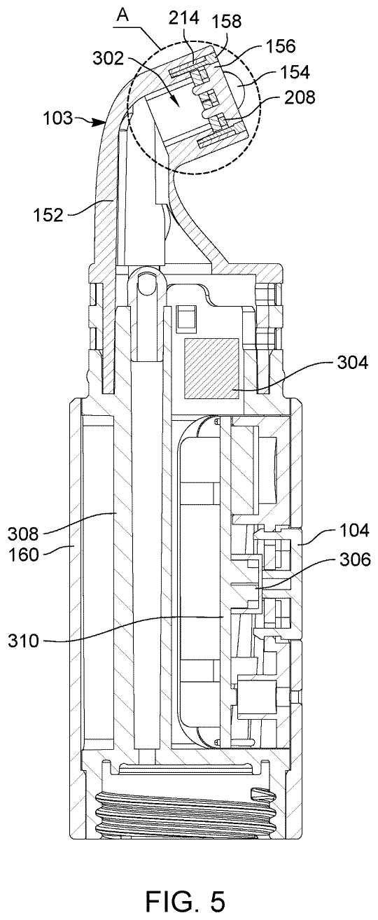

Referring to FIG. 1 to FIG. 6, the multi-functional bottle head provided in the embodiment of the present application is illustrated. The multi-function bottle head comprises a housing 106, a massage piece 154, a stimulation element 208, a light transmission plate 156, and a printed circuit board 310. The housing 106 has an input end 101 and an output end 103, the input end 101 connects the bottle body 108. The output end 103 is arranged relative to the input end 101. The output end 103 of the housing 106 is provided with mounting holes 302. The massage piece 154 is used to evenly apply the liquid medicine to the skin and to massage the skin. The massage piece 154 is installed at the output end 103 of the housing 106. The stimulation element 208 is used to provide alternate therapy to the skin. The stimulation element 208 is installed in the mounting holes 302. The light transmission plate 156 is installed in the mounting holes 302, and the light transmission plate 156 is positioned on one side that the stimulation element 208 is at distal end from the input end 101. The Printed circuit board 310 drives the one or more stimulation elements 208. The Printed circuit board (PCB) 310 is installed in the housing 106, and the PCB 310 is electrically connected with the one or more stimulation elements 208. The massage piece 154 is used for even application of liquid medicine on to the skin, and massaging the skin.

By adopting the one or more stimulation elements 208, and one or more massage piece 154, the bottle head provides the effect of physiotherapy and skin care. This improves the degree of integration degree of the product, reducing the number of accessories, thereby helping in reducing the volume and size of the product.

By adopting the light transmission plate 156, the light of the stimulation elements 208 can be allowed to eject, and the stimulation elements can be prevented from direct contact with the skin. The liquid medicine can be prevented from polluting or corroding the stimulation element 208 or the circuit.

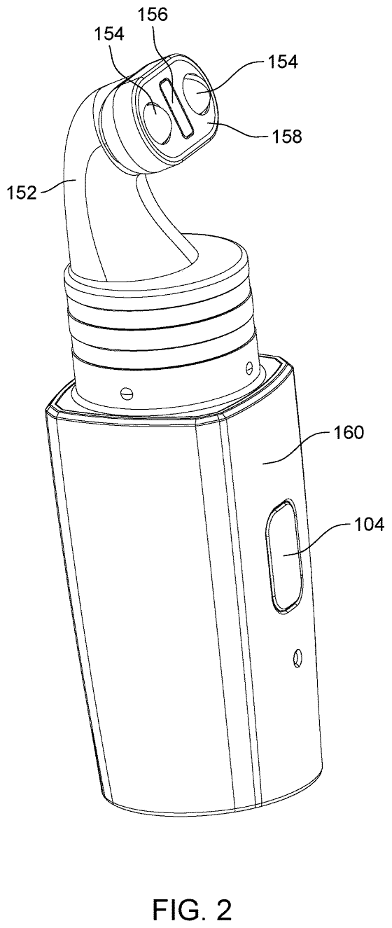

Referring to FIG. 2 to FIG. 6, the output end 103 of the housing 106 is equipped with a limiting plate 158. The limiting plate 158 is used for placing the massage piece 154 at the output end 103. The limiting plate 158 is provided with a first opening 202 and a second opening 204, the massage piece 154 exposes the first opening 202, and the light transmission plate 156 is placed in the second opening 204. By adopting the limiting plate 158, the massage piece 154 and the light transmission plate 156 can be prevented from falling off from the output end 103 of the housing 106, the stability of the light transmission plate 156 and the massage piece 154 is guaranteed, and the stimulation element 208 is conveniently sealed, and the processing and assembly of the output end 103 are convenient.

Referring to FIG. 2 to FIG. 6, the limiting plate 158 is provided with a positioning frame 206 in the matching insertion mounting hole 302, and the one or more stimulation elements 208 are placed in the positioning frame 206. The inner cavity of the positioning frame 206 forms a second opening 204, which is convenient for fixing and sealing the light transmission plate 156. By adopting the positioning frame 206, the position of the limiting plate 158 at the output end 103 can be conveniently located, and the assembly of the limiting plate 158 is convenient. Alternatively, a supporting frame 354 is arranged in the mounting holes 302. The supporting frame 354 is inserted into the positioning frame 206 in conjunction with the stopper, and the one or more stimulation element 208 is positioned with a stopper. By using a supporting frame 354 to insert a positioning frame 206, the one or more stimulation elements 208 can be blocked from being far away from the light transmission plate 156, and the relative stability of the position of the one or more stimulation elements 208 and the light transmission plate 156 is guaranteed.

Referring to FIG. 2 to FIG. 6, one end of the light transmission plate 156 close to the stimulation element 208 is provided with a first flange 252, a second flange 352 is arranged at one end of the second opening 204 away from the input end 101, and the second flange 352 is positioned with a stop to locate the first flange 252. By adopting the first flange 252 and the second flange 352, the light transmission plate 156 can be prevented from moving in the direction away from the stimulation elements 208, and the relative stability of the position of the stimulation element 208 and the light transmission plate 156 is guaranteed. The supporting frame 354 and the second flange 352 are coordinated, so that the stimulation element 208 and the light transmission plate 156 are confined to the positioning frame 206, and the positions of the stimulation element 208 and the light transmission plate 156 are kept stable. The first flange 252 and the second flange 352 may be connected together by pasting, interference fitting or integrated injection molding, etc., to ensure the sealing and prevent the liquid medicine from entering the corrosive stimulation element 208.

Referring to FIG. 2 to FIG. 6, the mounting holes 302 comprises a first hole section 212 and a second hole section 216 for the line to pass through, one end of the first hole section 212 close to the input end 101 is connected with the second hole section 216, and the light transmission plate 156 and the stimulation element 208 are located in the first hole section 212. In this way, it is convenient to connect stimulation element 208 and printed circuit board 310.

Referring to FIG. 2 to FIG. 6, the massage piece 154 is a ball. The output end 103 has a groove 210 matched with the ball and a liquid outlet hole communicated with the bottom of the groove 210. The diameter of the first opening 202 is smaller than the diameter of the ball. This makes it easy to transfer the liquid medicine to the groove 210 so that the liquid can be evenly applied to the skin as the ball rolls. Because the diameter of the first opening 202 is smaller than the diameter of the ball, the ball can be prevented from falling off, so that the machining accuracy of the groove 210 is conducive to reducing and the assembly of the ball is convenient. In other embodiments of the present application, the massage piece 154 may also be a structure such as a roller or a protrusion.

In an embodiment of the present invention, the stimulation element 208 is a Light Emitting diode that provides phototherapy to a user. The phototherapy source comprises a board 258 and a plurality of LED (Light Emitting Diode, light-emitting diode) lamp beads 260, a plurality of LED lamp beads 260 are arranged on the board 258, and the board 258 is electrically connected with the printed circuit board 310. By adopting a plurality of LED lamp beads 260, the light intensity can be improved, the uniformity of the light can be improved, and the phototherapy effect can be improved. Different phototherapy effects can also be obtained when multiple LED lamp beads 260 colors are different. Optionally, LED lamp beads 260 can include at least one of red LED lamp beads and blue LED lamp beads; in this way, different phototherapy effects can be achieved.

Referring to FIG. 1 to FIG. 3, a butting block 254 is arranged between two adjacent LED lamp beads 260, the butting block 254 is arranged on one side of the light transmission plate 156 close to the board 258, and the butting block 254 is supported on the board 258. By adopting the butting block 254, the LED lamp bead 260 can be prevented from being subjected to the pressure of the board 258 and the light transmission plate 156, the spacing between the board 258 and the light transmission plate 156 is guaranteed, and the phototherapy light source is protected. Arrange the butting block 254 between the adjacent two LED lamp beads 260, help to improve the stability of the distance between the board 258 and the light transmission plate 156.

Referring to FIG. 2 to FIG. 6, a positioning holes 262 is formed in the board 258, a positioning column 256 is arranged in the light transmission plate 156, and the positioning column 256 is inserted into the positioning holes 262 in conjunction with the positioning column 256. By adopting positioning column 256 to cooperate and insert positioning holes 262, it is convenient for the alignment between the stimulation element 208 and the light transmission plate 156, and is convenient for assembly. Optionally, the number of positioning holes 262 is two, the two positioning holes 262 are arranged along the length direction of the board 258, the number of positioning columns 256 is two, and the two positioning columns 256 correspond to the two positioning holes 262 one-to-one respectively. By adopting two positioning holes 262 to cooperate with two positioning columns 256 respectively, help to improve the stability of the position of one or more stimulation element 208 and the light transmission plate 156.

In an alternative embodiment, the positioning column 256 is arranged on the butting block 254, so that the area of the positioning column 256 and the butting block 254 occupying the board 258 can be reduced.

Referring to FIG. 2 to FIG. 6, the bottlehead may comprises a plurality of massage pieces. The plurality of massage pieces 154 are arranged around the stimulation element 208. In this way, the massage area can be increased, the application efficiency of the liquid can be improved, and the efficiency of massage and beauty skin care can be improved. Optionally, the number of massage pieces 154 is two, and the two massage pieces 154 are respectively positioned at opposite sides of the stimulation element 208.

In another embodiment of the present application, the multi-functional bottle head further comprises an inductive piece for controlling the start and stop of the one or more stimulation elements 208, and the inductive piece is electrically connected with the printed circuit board 310. By adopting printed circuit board 310 and inductive part electrical connection, can realize the control of the start and stop of the one or more stimulation elements 208. Optionally, the sensing piece may be a pressure sensor for controlling the opening of the stimulation element 208 when the skin pressure is sensed, a displacement sensor for opening the stimulation element 208 when sensing the skin movement, an acceleration sensor for turning on the stimulation element 208 when the acceleration reaches a preset change value, or a gravity sensor for turning on the stimulation element 208 when sensing the inclination angle reaching a preset value.

The multi-functional bottle head further comprises a switch 306 for controlling the start and stop of the stimulation element 208, and the switch 306 is electrically connected with the printed circuit board 310. In this way, controlling the start and stop of the stimulation element 208 is convenient. Optionally, the housing 106 is provided with a pressing member 104, and the pressing member 104 is used for pushing the switch 306 so that the switch 306 can be easily opened or closed.

The multi-functional bottle head further comprises a battery 304 installed in the housing 106, and the battery 304 is electrically connected with the printed circuit board 310. In this way, it is possible to supply power to the printed circuit board 310 and the stimulation element 208. Battery 304 can be rechargeable, and this is conducive to improving service life.

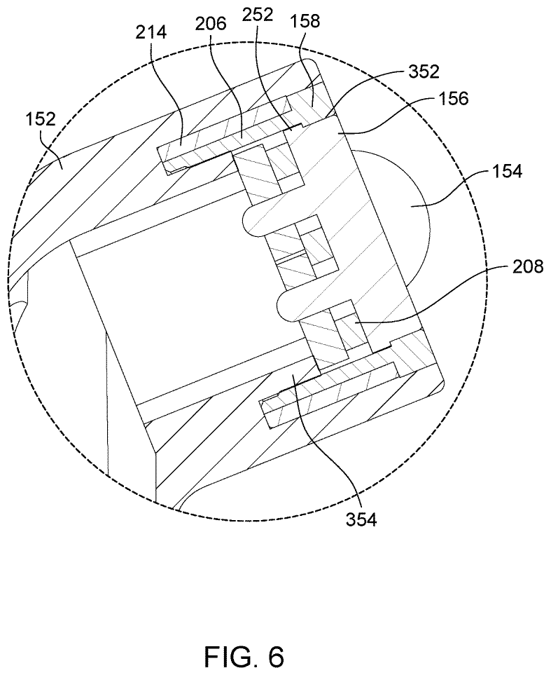

Referring to FIG. 2 to, FIG. 6 the housing 106 comprises a first housing 152, a mounting seat 214, a second housing 160 and a bracket 308, the second housing 160 is sleeved outside the bracket 308, one end of the first housing 152 is connected with the bracket 308, and the mounting seat 214 is installed at the other end of the first housing 152. In this way, it is convenient for the processing and assembly of housing 106. Optionally, a diversion hole is formed in the bracket 308, the diversion hole is used for communicating the liquid outlet hole and the bottle body 108, and the groove 210 is arranged on the mounting seat 214, so that the processing of the mounting seat 214 can be convenient, and the mounting seat 214 can be processed with wear-resistant material, and the structural accuracy and wear-resistant performance of the mounting seat 214 are improved.

Referring to FIG. 1 to FIG. 6, the embodiment of the present application also provides a bottle body, comprises a bottle body 108, and also comprises a multi-functional bottle head in any of the above embodiments, and the input end 101 of the housing 106 is connected with the bottle body 108. By adopting the multi-functional bottle head in the above-mentioned embodiment, the effects of physiotherapy and skin care can be realized, the integration degree of the product is improved, the product volume is conducive to reducing the volume of the product, the user is made to be more convenient to store and carry, and the user experience is helped to be improved.

Optionally, the bottle body further comprises a cap body 102, and the cap body 102 is capped outside the first housing 152 to protect the output end 103.

In an embodiment of the present invention, a liquid flow mechanism in the multi-functional bottlehead is provided. The multi-functional bottle head comprises: a shell having an assembly segment for being connected with a bottle body and an export segment connected with the assembly segment; the assembly segment is provided with a first runner hole. A derivation segment is provided with a second runner hole, and the outlet end of the first runner hole is connected to the inlet end of the second runner hole. The cross-sectional area of the derivation segment is less than the cross-sectional area of the assembly segment, and the cross-sectional area of the middle part of the derivation segment is less than the cross-sectional area of two ends of the derivation segment; and a coating part is used for applying the liquid medicine output at the outlet end of the second runner hole to the skin and massaging the skin, and the coating part is installed at the outlet end of the second runner hole.

The assembly segment can be connected with the bottle body to facilitate the output of the liquid medicine in the bottle body. The second runner hole is communicated with the first runner hole in the derivation segment, so that the liquid medicine can be transported to the coating part, so that the coating part can evenly apply the liquid medicine to the skin. The cross-sectional area of the derivation segment is smaller than the cross-sectional area of the assembly segment, such that the size of the bottle head mechanism close to the skin is reduced, which helps to reduce the interference with other parts during the application and massage process. By controlling the cross-sectional area of the middle part of the derivation segment to be smaller than the cross-sectional area of the two ends of the derivation segment, the size of the derivation segment close to the end of the skin can be guaranteed, to ensure the size of the massage and application of the drug site, and the middle part of the derivation segment is thinner, and it is easier to avoid collision with the user's nose and other positions, so as to improve the user's experience.

In an embodiment, the derivation segment comprises a connecting segment, a gradient segment and a supporting segment, the connecting segment is connected with the assembly segment, the supporting segment is connected with the coating part, the gradient segment connects the supporting segment with the connecting segment, and the cross-sectional area of the gradient segment is gradually reduced from one end close to the connecting segment to one end away from the connecting segment.

The gradient segment is arc-shaped, and the bending angle of the gradient segment is 20°-85°. The second runner hole is arc-shapedly bent.

In an embodiment, the multi-functional bottlehead comprises a plurality of coating parts. The supporting segment is provided with a plurality of support areas, the plurality of support areas are arranged around one end of the gradient segment far away from the connecting segment, and the coating parts respectively corresponding to a plurality of the support areas; the number of the second runner holes is a plurality, and the plurality of the second runner holes correspond to a plurality of support areas one by one.

In an embodiment, the bottle head further comprises a diverter pipe. The diverter pipe comprises a main pipe section and a plurality of branch pipe sections, one end of the main pipe section is connected with the outlet end of the first runner hole, one end of each branch pipe section is connected with the other end of the main pipe section, and the other end of each branch pipe section is connected with the inlet end of the corresponding second runner hole.

The supporting segment has an embedded grove for the coating part. The coting piece is ball-shaped. The bottom of the groove is provided with a diversion groove connected with the outlet end of the second runner hole.

The assembly segment comprises a bracket and a casing arranged outside the bracket. The bracket is connected with the derivation segment. The bracket is provided with a first runner hole, and the bracket is provided with a circuit assembly for cosmetic therapy.

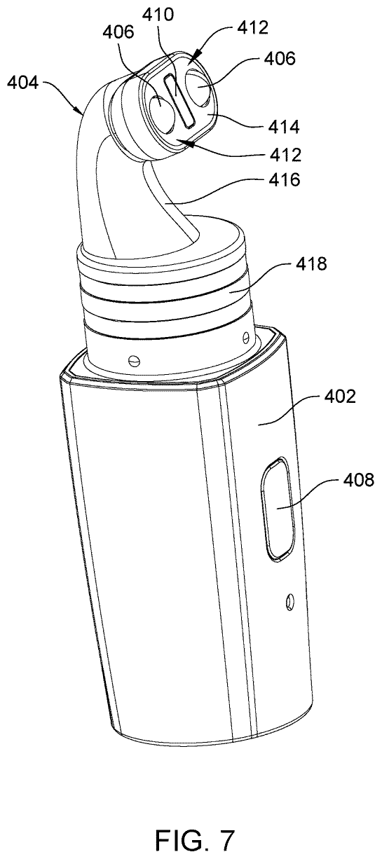

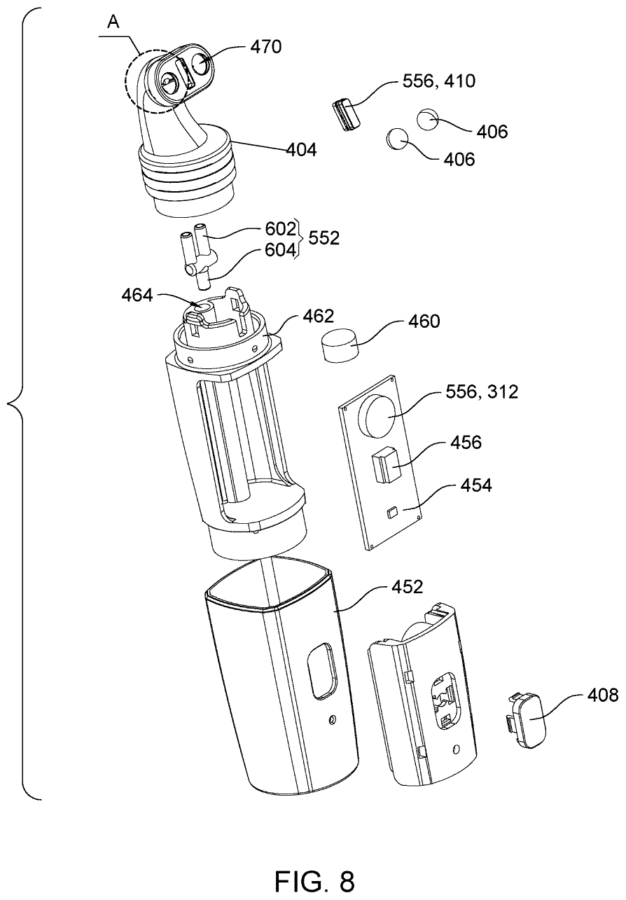

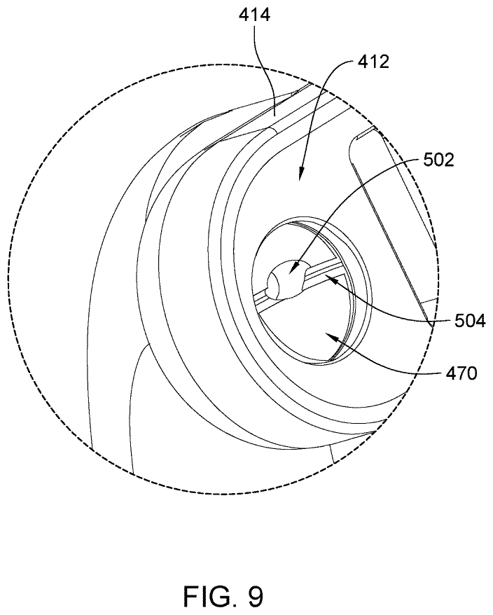

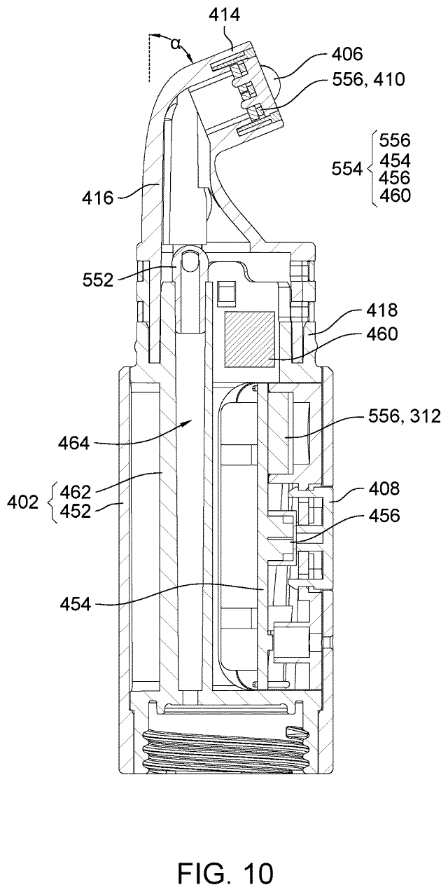

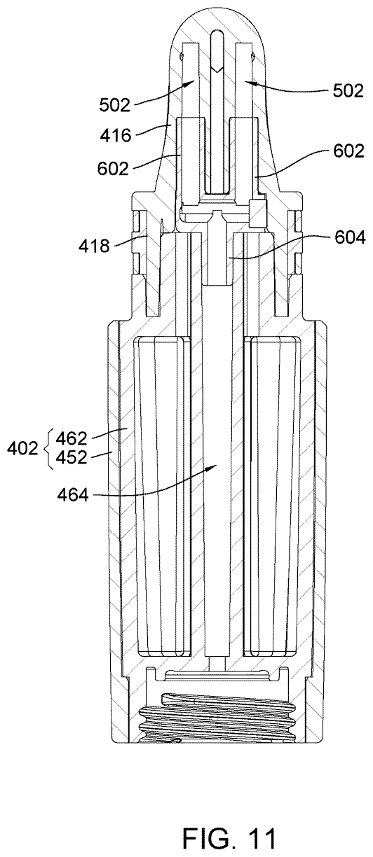

Referring to FIG. 7 to FIG. 11, the multi-functional bottle head provided in the embodiment of the present invention is described. The multi-functional bottle head comprises a housing and a coating part 406. The housing comprises an assembly segment 402 and a derivation segment 404. The assembly segment 402 is used to connect the bottle body. The derivation segment 404 is connected with the assembly segment 402. The assembly segment 402 is provided with a first runner hole 464, and the derivation segment 404 is provided with a second runner hole 502. The outlet end of the first runner hole 464 is connected with the inlet end of the second runner hole 502. The cross-sectional area of the derivation segment 404 is less than the cross-sectional area of the assembly segment 402, and the cross-sectional area of the middle part of the derivation segment 404 is less than the cross-sectional area of the two ends of the derivation segment 404.

The coating part 406 is used to apply the liquid medicine output at the outlet end of the second runner hole 502 to the skin and massage the skin. The coating part 406 is installed at the outlet end of the second runner hole 502. By adopting the coating part 406, the medicine can be evenly applied to the skin when the medicine is output while simultaneously massaging the skin.

Through adopting assembly segment 402, it can be connected with bottle body, so that the liquid medicine in bottle body can be easily output. By adopting the derivation segment 404, the second runner hole 502 is communicated with the first runner hole 464, so that the liquid medicine can be transported to the coating part 406, so that the coating part 406 can evenly apply the liquid medicine on the skin. By controlling that the cross-sectional area of the derivation segment 404 is smaller than that of the assembly segment 402, the size of the bottle head close to the skin end can be reduced, and the interference with other parts during the application and massage process can be reduced.

By controlling that the middle cross-sectional area of the derivation segment 404 is smaller than the cross-sectional area of the two ends of the derivation segment 404, the size of the derivation segment 404 close to the skin end can be guaranteed, so as to ensure the size of the massage and application drug site, and the middle part of the derivation segment 404 is thinner, and it is easier to avoid collision with the user's nose and other positions, so as to facilitate the user's use experience.

In an embodiment of the present invention, the drugs filled within bottles can include but are not limited to beauty and skin care products, massage oils, etc. The assembly segment 402 and the derivation segment 404 can be assembled together after processing separately, so that the processing difficulty is conducive to being reduced.

Referring to FIG. 7 to FIG. 11, the derivation segment 404 comprises a connecting segment 418, a gradient segment 416 and a supporting segment 414. The connecting segment 418 is connected with the assembly segment 402. The supporting segment 414 is connected with the coating part 406, the gradient segment 416 is connected to the supporting segment 414 and the connecting segment 418.

The cross-sectional area of the gradient segment 416 is gradually reduced from one end close to the connecting segment 418 to one end away from the connecting segment 418.

By adopting gradient structure: the overall structural strength change can be balanced; the installation of coating part 406 is convenient, and is conducive to the processing of the second runner hole 502; prevents the derivation segment 404 from breaking when demoulding. On the other hand, it makes the product more coordinated and looks more beautiful.

Optionally, the connecting segment 418 may be detachably connected with the assembly segment 402, or be fixed by pasting and welding so that the derivation segment 404 and the assembly segment 402 can be manufactured, reducing the processing difficulty.

In an embodiment of the present invention, the gradient segment 416 is curved in shape of an arc, and the bending angle of the gradient segment 416 is at 20°-85°. The gradient segment 416 is curved in an arc, which can better fit the skin when used, and the transition over the surface is smooth to avoid edges and corners scratching the skin.

The second runner hole 502 is curved in an arc shape, which is convenient for the processing of the second runner hole 502, and is conducive to preventing the second runner hole 502 from locally forming a dead angle of liquid medicine flow. Optionally, the bending angle of the gradient segment 416 is 30°, 50°, 60° or 75°, etc., which can adjust the angle of the part of the beauty massage, so that the user's hand-held angle is more natural and comfortable, so that the user can obtain a better use experience.

Referring to FIG. 7 to FIG. 11, the multi-functional bottle head comprises a plurality of coating parts 406. The supporting segment 414 is provided with a plurality of support areas 412, the plurality of support areas 412 are arranged around one end of the gradient segment 416 away from the connecting segment 418, and the plurality of coating parts 406 correspond to a plurality of support areas 412 one-to-one respectively. The second runner holes 502 are plurality in number, and the plurality of second runner holes 502 correspond one-to-one with a plurality of support areas 412 respectively.

By adopting a plurality of support areas 412, a plurality of coating parts 406 can be installed, so that the application efficiency of the drug can be improved, and a large massage area can be obtained.

Optionally, the number of coating parts 406 are two, the number of support areas 412 is two, and two coating part 406 are adopted, so that the size of the supporting segment 414 can be controlled, so as to be better suitable for the cosmetic massage of the skin of the nasal side and other parts.

Referring to FIG. 7 to FIG. 11, the multi-functional bottle head further comprises a manifold pipe 552. The manifold pipe 552 comprises a main pipe section 604 and a plurality of branch pipe segments 602. One end of the main pipe section 604 is connected with the outlet end of the first runner hole 464. One end of each branch pipe segments 602 is connected with the other end of the main pipe section 604, and the other end of each branch pipe segments 602 is connected with the inlet end of the corresponding second runner hole 502.

By adopting a manifold pipe 552, the drug can be shunted to each coating part 406, so that the drug can be applied to the skin more evenly, and the processing of the shell and the sealing of the flow channel can be facilitated. Optionally, the number of branch pipe segments 602 is two, and the number of second runner holes 502 is two, so that the liquid medicine can be distributed to two coating parts 406.

In an embodiment of the present application, the coating part 406 is a ball, and a groove 470 accommodating a ball embedding is formed in the supporting segment 414. The bottom of the groove 470 is provided with a diversion groove 504 that is connected with the outlet end of the second runner hole 502. In this way, when the liquid medicine flows out from the second runner hole 502, it can be better dispersed to the diversion groove 504, and the contact with the ball is more sufficient, the resistance of the ball rolling is reduced, and the uniformity of the drug on the ball is improved. Alternatively, the diversion groove 504 is a strip-shaped groove. The multi-functional bottle head comprises a plurality of diversion grooves 504. The plurality of diversion grooves 504 are arranged around the outlet end of the second runner hole 502, so that the contact between the liquid medicine and the ball can be more sufficient.

In an embodiment of the present application, the assembly segment 402 comprises a bracket 462 and a shell 452 sleeved outside the bracket 462. The bracket 462 is connected with the derivation segment 404. The first runner hole 464 is formed in the bracket 462, and a circuit assembly 554 for cosmetic therapy is installed on the bracket 462, conveniently fixing the circuit assembly 554 through the bracket 462. This ensures the stability of the circuit assembly 554. Through the bracket 462 and the shell 452, the processing of the assembly segment 402 can be facilitated, and the appearance quality of the assembly segment 402 is improved. In addition, the bracket 462, the shell 452 and the derivation segment 404 can be processed separately and then assembled, so that the processing difficulty of the product is conducive to simplifying the product and reducing the production cost.

In an embodiment of the present invention, the circuit assembly 554 comprises one or more stimulation element 556 for performing a cosmetic physiotherapy. A circuit board 454 is electrically connected to the one or more stimulation element 556, and a switch button 456 for controlling the one or more stimulation element 556 and a power supply 460 is electrically connected to the circuit board 454. The switch button 456 and the power supply 460 are electrically connected with the circuit board 454, and the circuit board 454 and the power supply 460 are mounted on the bracket 462. Optionally, the one or more stimulation element 556 may be a phototherapy light source 410 for performing phototherapy, a vibrating motor 312 for vibrating massage, an electrode sheet for microcurrent stimulation of facial muscles, or an ultrasonic generator for introducing liquid medicine into the skin. By adopting the one or more stimulation element 556, the skin can be cosmetic massage, so that the bottle head can have multiple functions, and help to improve the user experience. Optionally, the switch button 456 may also be a mechanical switch or a sensor such as touch, photoelectric induction or gravity induction to realize the start and stop of the one or more stimulation element 556.

Optionally, a pressing member 408 is installed on the housing, and the pressing member 408 is used for pushing the switch button 456. In this way, it is convenient for the user to turn on or off the switch button 456.

In an embodiment of the present application, one or more stimulation element 556 comprises a phototherapy light source 410 mounted in the derivation segment 404. The phototherapy light source 410 is installed in a supporting segment 414, and the phototherapy light source 410 is electrically connected with the circuit board 454, so that the skin can be phototherapy.

In one embodiment of the present application, the one or more stimulation element 556 comprises a vibrating motor 312 mounted on the bracket 462. The vibrating motor 312 is electrically connected with the circuit board 454, and is connected with the vibrating motor 312 through the bracket 462, which is conducive to improving the stability of the vibrating motor 312 and preventing the electrical connection part from being broken in the vibration process of the vibrating motor 312.

The embodiment of the present invention also provides an accommodating bottle, comprises a bottle body, and the multi-functional bottle head. The assembly segment 402 is connected with the bottle body, and the inlet end of the first runner hole 464 is connected with the bottle body. By adopting the bottle head in the above embodiment, the size of the derivation segment 404 close to one end of the skin can be guaranteed, so that the size of the massage and application drug site can be easily guaranteed, and the middle part of the derivation segment 404 is thinner, and it is easier to avoid collision with the user's nose and other positions, so as to facilitate the user's use experience.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

1. A multi-functional bottle head, comprising:
a housing having a first end for connecting to a bottle main body and a second end;
a mounting hole on the second end;
one or more massage piece installed on the second end of the housing;
one or more stimulation element installed in the mounting hole.

2. The multi-functional bottle head of claim 1, wherein the second end of the housing is provided with a limiting plate, said limiting plate has a first opening for the one or more massage piece and a second opening for a light transmission plate, diameter of the first opening is less than the diameter of the massage piece.

3. The multi-functional bottle head of claim 2, wherein the limiting plate comprises a positioning frame having an inner cavity for positioning the at least one stimulation element.

4. The multi-function bottle head of claim 2, wherein the bottle head further comprising a first hole section having a first opening and a second opening corresponding to the first opening and the second opening of the limiting plate, the first opening comprises one or more grooves for placing the one or more massage piece.

5. The multi-functional bottle head of claim 2 further comprising a second hole section in the second end of the housing, the second hole section having a first opening and second opening corresponding to the first opening and the second opening of the limiting plate.

6. The multi-function bottle head of claim 1, wherein the one or more massage piece is a ball.

7. The multi-functional bottle head of claim 1, wherein the at least one stimulation element is selected from a group consisting of Light Emitting Diodes (LEDs), lasers, heating elements, cooling elements, vibration elements, electrodes, micro-current element and combinations thereof.

8. The multi-functional bottle head of claim 2, wherein the light transmission plate has a butting block to separate two adjacent stimulation elements.

9. The multi-functional bottle head of claim 1 further comprising an inductive switch device for regulating activation and control of the one or more stimulation elements.

10. A multi-functional bottle head comprising:
a shell comprising:
an assembly segment for connecting with a bottle body, the assembly segment has a first runner hole;
a derivation segment having a first end and a second end, the second end is connected with the assembly segment, the derivation segment has a plurality of second runner hole, wherein an outlet end of the first runner hole is connected with an inlet end of each of the plurality of second runner hole;
wherein cross-sectional area of the derivation segment is less than cross-sectional area of the assembly segment; and
one or more coating parts installed at an outlet end of the second runner hole, the coating part applies a liquid medicine to a user's skin.

11. The multi-functional bottle head of claim 10, wherein the derivation segment comprises:
a connecting segment connected with the assembly segment;
a supporting segment connected with the one or more coating part;
a gradient segment connects the supporting segment with the connecting segment;
wherein cross-sectional area of the gradient segment decreases moving from the connecting segment to the supporting segment.

12. The multi-functional bottle head of claim 11, wherein the gradient segment is bending arc-shaped.

13. The multi-functional bottle head of claim 12, wherein arc of the gradient segment bends at an angle of 20°-85°.

14. The multi-functional bottle head of claim 10, wherein the second runner hole is bent in arc-shaped.

15. The multi-functional bottle head of claim 11, wherein the supporting segment is provided with a plurality of support areas, each of the plurality of support areas corresponds to each of the plurality of second runner holes.

16. The multi-functional bottle head of claim 15 further comprising a manifold pipe, the manifold comprises a main pipe section and a plurality of branch pipe sections diverting from the main pipe section, said main pipe section is connected with the outlet end of the first runner hole, and the outlet end of each of the plurality of branch pipe section is connected with the inlet end of the corresponding second runner hole.

17. The multi-functional bottle head of claim 11, wherein the one or more coating parts are ball shaped accommodated in a groove located in the supporting segment.

18. The multi-functional bottle head of claim 17, wherein bottom of the groove is provided with a diversion groove connected with the outlet end of each of the plurality of second runner holes.

19. The bottle head of claim 11, wherein the assembly segment comprises a bracket and a shell sleeved outside a support, the support is connected with the derivation segment.

20. The multi-functional bottle head of claim 10 further comprising a circuit assembly comprises one or more stimulation element, a circuit board connected to the one or more stimulation element, a switching device and a power supply.

21. The multi-functional bottle head of claim 20, wherein the one or more stimulation element is selected from a group consisting of Light Emitting Diodes (LEDs), lasers, heating elements, cooling elements, vibration elements, electrodes, micro-current element and combinations thereof.
